(19) United States
(12) Patent Application Publication
(10) Pub. No.: US 2014/0091064 A1
(43) Pub. Date: Apr. 3, 2014

(54) METHOD OF WELDING BY MEANS OF A LASER

(71) Applicant: NEXANS, Paris (FR)

(72) Inventors: Ralf Egerer, Seesen (DE); Holger Schulz, Hannover (DE); Olaf Petersen, Hannover (DE); Christian Reiter, Sarstedt (DE)

(21) Appl. No.: 13/792,815

(22) Filed: Mar. 11, 2013

(30) Foreign Application Priority Data
Mar. 27, 2012 (EP) 12 305 353.0

(51) Int. Cl. B23K 26/00; B23K 26/26

(52) U.S. Cl. CPC B23K 26/0051; B23K 26/265
USPC 219/59.1; 219/121.64

(57) ABSTRACT

Method of welding edges which are placed against each other of at least one workpiece of metal by means of a laser is indicated, in which the areas of the workplace located at the edges are subjected to a pretreatment for increasing the absorption capacity of the light of the laser. For this purpose, initially color is sprayed or splashed onto the areas of the workpiece located at the edges, while avoiding any mechanical contact of the workpiece, by means of a device (7) which emits the color, and the edges of the workpiece are subsequently welded together by means of a laser (11).

### RELATED APPLICATION

This application claims the benefit of priority from European Patent Application No. 12 305 353.0, filed on Mar. 27, 2012, the entirety of which is incorporated by reference.

### BACKGROUND

1. Field of the Invention

The invention relates to a method. of welding edges placed. against each other of at least one workpiece of metal by means of a laser, in which the areas of the workpiece located at the edges are subjected to a preliminary treatment for increasing the absorption capacity of the light of the laser (EP 1 184 128 B1).

2. Description of Related Art

In a preferred embodiment, the workpiece consists of copper or aluminum or an alloy of these materials, wherein particularly the aluminum may be coated with a polymer. Two workpieces which had been previously separated from each other can be placed. against each other at the edges to be welded, for example, two strips which are to be welded together at their end faces. However, it may also only be one strip which, in accordance with conventional technology, is shaped into a pipe as it enters longitudinally in such a way that the two edges thereof abut against each other along a slot extending in the longitudinal direction. In the following specification—representative for all possible workpieces to be welded—a strip bent into a pipe which is welded at its edges by means of a laser for producing a circumferentially closed pipe is considered the workpiece.

Welding the edges of a strip of metal whose edges rest against each other at a slot by means of a laser is known per se from EP 0 703 017 131. In this regard, it has been found that the absorption of the laser light by the metal is very slight and is dependent on the wave length of the laser radiation. A good portion of the laser energy is reflected at the surface of a strip of metal. This has the result that a lot of energy has to be utilized for melting the metal for the welding process.

EP 1 714 729 B1 describes a method with a device for laser welding in which a YAG laser and a laser with low wave length act in a pulsed manner on a welding zone. DE 10 2004 027 229 134 describes a method of welding workpieces of aluminum or an aluminum alloy in which, in addition to a welding laser, a second pulsed laser is used by means of which initially an oxide layer of the aluminum is evaporated. in both of these two methods two lasers are used which simultaneously act on the welding zone during the welding process.

EP 1 184 128 B1 mentioned above describes a method for manufacturing a pipe of copper in which a copper strip is shaped as it enters longitudinally into a pipe with a slot extending in the longitudinal direction. The edges of the copper strip, located at the slot, are welded. together by means of a laser.

Prior to the welding process, the areas of the edges of the copper strip are mechanically roughened and are, for example, wetted with petroleum. For example, embossing rollers are used for roughing the copper strip which mechanically changes the surface of the copper strip. The petroleum is applied in a wetting station by means of a felt strip which is subject to wear.

### OBJECTS AND SUMMARY

It is the object of the invention to further improve the above described method, particularly to simplify it.

In accordance with the invention, this object is met by
spraying or splashing color onto the areas of the pipe which are located at the edges, while avoiding any mechanical contact of the workpiece by a device dispensing the color, and
by subsequently welding the edges of the pipe together by means of a laser.

The color, which in a preferred embodiment is the color black, is applied in this method with a device onto the edges of the pipe, wherein the device does not contact the pipe or which is not contacted by the metal strip which is shaped into the pipe. The device—a spraying device or splashing device—is accordingly not subject to any wear while carrying out the respect to time. The surfaces of the areas at the edges of the pipe to be welded together are prepared. by the color in such a way that the absorption of laser light is significantly improved in these areas. Therefore, a laser with reduced energy consumption can be used for the welding procedure for we the two edges of the pipe together. The method has the additional advantage that the two method steps—application of color, on the one hand, and welding on the other hand—can be carried out separate from each other with respect to location and time. Advantageously, in that case, the color can be applied already onto a metal strip which has not vet been shaped into a pipe. Shaping into a slotted pipe and welding of the slot by means of the laser can then be carried out at any chosen time.

### BRIEF DESCRIPTION OF THE DRAWINGS

The method according to the invention will be explained with the aid of the drawings in connection with embodiments.

In the drawing:

FIG. 1 is a schematic illustration. of a device for manufacturing a pipe.

FIG. 2 is a sectional view of FIG. 1, on a larger scale, along line II.

FIG. 3 is a top view of FIG. 2 in a further enlarged illustration.

FIG. 4 is a view of a detail of a metal strip.

FIG. 5 is an embodiment of a device for manufacturing a pipe which is modified as compared to FIG. 1.

### DETAILED DESCRIPTION

The laser for welding the edges of the pipe can be, for example, a laser having a wave length of at least 800 nm. Advantageously, a YAG laser is used whose wave length is, for example, 1,064 nm, However, it is also possible to use other solid body lasers and diode lasers whose wave lengths are, for example, between 808 nm and 1,070 nm. The use of a CO₂ laser with a wave length of 10,600 nm is also possible.

In accordance with preferred embodiments, the metal strip is of copper or aluminum or alloys of these materials. In the following it will be called “strip” for short. Also in a preferred embodiment, a black color is sprayed or splashed onto the strip, advantageously as closed layers. These layers may have a thickness of, for example, between 0.5 μm and 100 μm.

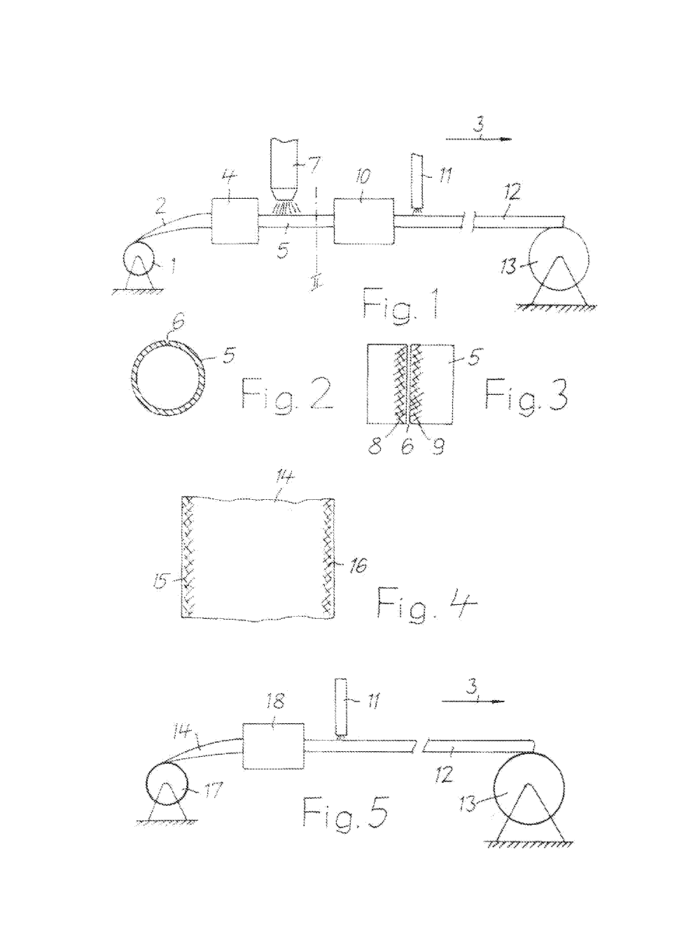

The method according to the invention will be explained as an example initially in accordance with FIG. 1:

A strip 2 is pulled off from a coil 1 in the direction of arrow 3 by means of a conventionally known feeding device which is not illustrated for simplicity's sake. The strip 2 is shaped in an also conventionally known shaping device 4 into a slotted pipe 5 (FIG. 2) in which the edges of the strip 2 are arranged so as to abut at a slot 6 extending in the longitudinal direction.

The slotted pipe 5 is subsequently passed under at least one device 7 or is guided along such a device by means of which color is sprayed or splashed onto the areas 8 and 9 of the strip 2, including the end faces thereof, for improving the absorption. capacity of laser light. Subsequently, the slotted pipe 5 can travel through a holding device 10 by means of which the edges of the strip 2 are held tightly closed together. The slot 6 is then welded by means of a laser 11. The finished pipe 12 can subsequently be wound onto a coil 13.

As described, color is applied by the at least one device 7 onto the areas 8 and 9 of the strip 2 where the strip 2 has already been shaped into the slotted pipe 5. However, this could also be done on the still open pipe already prior to the shaping device 4 or also in the area thereof. In these two cases, the holding device 10 can be omitted. However, a holding device could then also be arranged. behind the laser 11. In all, the above described cases, the application of color onto the strip by the at least one device 7 and welding of the slot 6 by the laser 11 take place in one work step.

The two method steps carried out in the described method can also be carried out separate of each other with respect to place and time. For this purpose, according to FIG. 4 color can be applied by means of a device corresponding to the device 7, onto a strip 14 for forming areas 15 and 16 with improved absorption capacity of laser light at the two edges of the strip, including the end faces thereof. The strip 14 is then pretreated at its edges to be welded together in such a way that it can absorb laser light in an improved manner. It can be wound onto a coil in this state.

The coil supporting the pretreated strip 14 is referred to with reference numeral 17 in FIG. 5. The strip 14 is pulled from the coil 17 and is shaped into a slotted pipe which corresponds to the slotted pipe 5, by means of a device according to FIG. 5 in a shaping device 18 corresponding to the shaping device 4 according to FIG. 1. The slot of the slotted pipe is welded directly following toe shaping device 18 by means of the laser 11 into the closed pipe 12 in such a way that it can be wound onto the coil 13.

The method described above with respect to the manufacture of a pipe can analogously also be used for two metal strips which are to be welded together at the end faces thereof.

1. Method of welding edges which are placed against each other of at least one workpiece of metal by means of a laser, in which the areas of the workpiece located at the edges are subjected to a pretreatment for increasing the absorption capacity of the light of the laser, said method comprising the steps of:
spraying or splashing color, initially, onto the areas of the workpiece located at the edges, while avoiding any mechanical contact of the workpiece a device which supplies the color, and
subsequently welding the edges of the workpiece together by means of a laser.

2. Method according to claim 1, wherein
a strip composed of metal is shaped as the workpiece while entering longitudinally into a pipe with a slot extending in its longitudinal direction where the edges of the strip are placed against each other,
spraying or splashing color onto the strip in the areas of the edges on both. sides of the slot, and
the edges of the pipe are welded together by means of a laser.

3. Method according to claim 1, wherein
workpieces having two edges are placed against each other with their edges,
the areas at the edges of both workpieces are sprayed or splashed with color, and
the edges of the two workpieces are welded by means of a laser.

4. Method according to claim I, wherein black color is used as color.
